(19) United States
(12) Patent Application Publication
(10) Pub. No.: US 2024/0017468 A1
(43) Pub. Date: Jan. 18, 2024

(54) Z MODULE

(71) Applicant: KRONES AG, Neutraubling (DE)

(72) Inventors: Max BRIKMANN, Thalmassing (DE); Florian GELTINGER, Donaustauf (DE); Juergen SOELLNER, Beratzhausen (DE)

(21) Appl. No.: 18/221,796

(22) Filed: Jul. 13, 2023

(30) Foreign Application Priority Data
Jul. 13, 2022 (DE) 10 2022 117 513.8

(51) Int. Cl. B29C 49/42; B29D 22/00

(52) U.S. Cl. CPC B29C 49/42069; B29C 49/4281; B29D 22/003; B29L 2031/712

(57) ABSTRACT

An apparatus for treating plastic containers includes a transport device which transports the plastic containers along a predetermined transport path, a blow module which has a blow molding machine for shaping plastic preforms into plastic containers, and a filler module which has a filling device for filling plastic containers with an, in particular, liquid product. The blow module and the filler module are arranged directly adjacent to one another, wherein the blow module has a transport starwheel on the outlet side, which transport starwheel is designed as a pitch varying starwheel and the plastic containers can be transferred directly from the pitch varying starwheel of the blow module to the filler module.

### BACKGROUND OF THE INVENTION

The present invention relates to an apparatus and to a method for treating plastic containers, in particular for producing plastic containers and for filling them with an, in particular, liquid product under aseptic conditions.

Blow molding machines and filling devices in non-aseptic and aseptic designs have long been known from the prior art. They are often designed in a modular design in combination with one another (blow machine-filler-block). There are considerable differences between the embodiments of aseptic and non-aseptic systems, for example due to the required clean room of an aseptic system and the technical effort associated therewith. For example, an aseptic blow module typically has a pitch varying starwheel and a pitch changing starwheel on the outlet side, and an aseptic filler module has five transport starwheels, wherein at least one of which is designed as a pitch varying starwheel. A transfer of plastic containers is carried out directly from the pitch changing starwheel of the blow module to the transport starwheels of the filler module.

In contrast thereto, a non-aseptic blow module has only one pitch varying starwheel, wherein it is possible to dispense with the pitch changing starwheel. Furthermore, in non-aseptic systems, the use of an orientation starwheel for aligning the plastic containers before filling is known.

Since the layout of a system changes or increases in general with the number of transport starwheels, in particular when installing additional special transport starwheels (e.g., orientation starwheel), and, in the case of an aseptic system, the demands on the clean room and the corresponding technical effort are significantly increased, the trend when developing new systems is to reduce the number of transport starwheels used to a minimum and to minimize the spatial extent of such a system.

Therefore, the object of the present invention is to provide an apparatus and a method for an aseptic system for producing and filling plastic containers which, compared to the prior art, require less technical effort and, at the same time, allows for increased variability to adapt to customer requirements.

This object is achieved according to the invention by two apparatuses and two methods according to the independent claims. Advantageous embodiments and developments are the subject matter of the dependent claims.

### SUMMARY OF THE INVENTION

An apparatus according to the invention for treating plastic containers has a transport device which transports the plastic containers along a predetermined transport path. The apparatus furthermore has a blow module which has a blow molding machine, in particular a stretch blow molding machine, for shaping plastic preforms into plastic containers. Furthermore, a filler module is provided which has a filling device for filling plastic containers with an, in particular, liquid product, wherein the blow module and the filler module have an interface which enables a side-by-side arrangement of the blow module and the filler module, and wherein the plastic containers can be transferred from the blow module to the filler module. Furthermore, the apparatus is arranged within a clean room.

According to the invention, the blow module and the filler module are arranged directly adjacent to one another, wherein the blow module has a transport starwheel on the outlet side, which transport starwheel is designed as a pitch varying starwheel and the plastic containers can be transferred directly from the pitch varying starwheel of the blow module to the filler module.

The plastic containers are preferably plastic bottles and particularly preferably PET bottles.

The apparatus preferably has a modular structure. The apparatus preferably has a blow module and a filler module. It would also be conceivable for the apparatus according to the invention to be part of a larger system and connected to further modules for closing the plastic containers, for labeling the plastic containers and for packaging the plastic containers.

Preferably, the apparatus is arranged in a clean room and particularly preferably the apparatus is configured such that it has an aseptic corridor within which the production of plastic containers, the transportation and a filling of the plastic containers takes place under aseptic conditions, while components of the apparatus which do not necessarily have to be arranged within the clean room are arranged outside the clean room. This relates, for example, to the drives of the transport devices, supply lines for flowable media and the like. Preferably, at least one clean room boundary is designed as a water lock, in particular in the case of rotating components of the apparatus.

The blow module preferably has an aseptic blow molding machine and particularly preferably an aseptic stretch blow molding machine. Preferably, previously sterilized and heated plastic preforms can be fed to the blow module, which can be shaped into plastic containers within the blow module by applying a flowable medium. Furthermore, the blow module preferably has an outfeed starwheel on the outlet side (downstream of the blow molding machine), which outfeed starwheel takes over the newly produced plastic containers from the blow molding machine. The outfeed starwheel is preferably a pitch varying starwheel. In an advantageous embodiment, the blow module has only a single transport starwheel on the outlet side, which is designed as a pitch varying starwheel, while in the prior art the blow module additionally has a further transport starwheel on the outlet side, which is designed, for example, as a pitch changing starwheel. The present invention therefore offers the advantage that this additional transport starwheel can be dispensed with, as a result of which the technical effort and the associated costs can be reduced.

In connection with the present invention, a pitch varying starwheel is understood to mean a transport starwheel which, during the transfer of plastic containers, maintains a pitch (circle division of the transport starwheel) and makes a transfer from each pitch to each pitch (1:1) but, at the same time, increases or reduces the distance between two successive plastic containers, which corresponds to an increase or decrease in the corresponding pitch circle.

Furthermore, in connection with the present invention, a pitch varying starwheel is understood to mean a transport starwheel which changes a pitch during the transfer of plastic containers, for example from each second pitch to each pitch (2:1) or from each pitch to each pitch (1:1). Preferably, the pitch changing starwheel can be switched manually or automatically.

The filler module preferably has an aseptic filling device for filling plastic containers with an, in particular, liquid product, and a plurality of transport starwheels for transferring the plastic containers between the blow module and the filling device. In one advantageous embodiment, the filler module has a maximum of four transport starwheels and preferably less than four transport starwheels for transferring the plastic containers between the blow module and the filling device. In comparison, five or more transport starwheels are typically used in the prior art.

Preferably, the blow module is an aseptic blow module and the filler module is an aseptic filler module. The two modules preferably have a complementary interface which enables an arrangement of the blow module and the filler module directly side-by-side. The interface is preferably designed such that in a state where the two modules are arranged side-by-side, the clean room boundaries of the two modules are adjacent to one another and the gap still present between them can be sealed in an airtight manner. Such sealing preferably takes place by welding.

In an advantageous embodiment, the plastic containers can be transferred directly from the transport starwheel, on the outlet side, of the blow module, which is preferably designed as a pitch varying starwheel, to the filler module and more precisely to the transport starwheels of the filler module. In an advantageous embodiment, the filler module has at least three transport starwheels, wherein a first transport starwheel of the filler module is a pitch varying starwheel and/or a second transport starwheel of the filler module is a pitch changing starwheel. A designation of the transport starwheels as the first or second transport starwheel has nothing to do with a predetermined sequence of the transport starwheels.

Preferably, the plastic containers can be transferred from a pitch of the blow molding machine to a pitch of the filling device and particularly preferably by the pitch changing starwheel of the filler module. Preferably, a pitch distance (between two successive transported plastic containers) can be changed by a pitch varying starwheel and preferably by more than one pitch varying starwheel. In this case, it is conceivable for the pitch distance to be variable in several steps, for example by means of a first pitch varying starwheel (as part of the blow module on the outlet side) and by a second pitch varying starwheel, which is designed, for example, as an infeed star wheel of the filling device. It would also be conceivable for a further transport starwheel of the filler module to be designed as a pitch varying starwheel.

As stated above, the blow module and the filler module have an interface which enables an arrangement of the two modules directly side-by-side, as a result of which the clean room boundaries of the two modules can adjoin. This offers the advantage that the structure of the clean room can be significantly simpler in design and that the technical effort for maintaining the aseptic conditions can also be reduced. Such a modular design and the corresponding interfaces of the individual modules make it possible to “insert” a further module between the blow module and the filler module, which also has complementary interfaces.

Therefore, the present invention is also directed to an apparatus for treating plastic containers having a transport device, which transports the plastic containers along a predetermined transport path. Furthermore, the apparatus has a blow module which has a blow molding machine for shaping plastic preforms into plastic containers, and a filler module which has a filling device for filling plastic containers with an, in particular, liquid product. Furthermore, the plastic containers can be transferred from the blow module to the filler module, wherein the apparatus is arranged within a clean room.

According to the invention, a transfer device for transferring the plastic containers is arranged between the blow module and the filler module, wherein the blow module has a transport starwheel on the outlet side, which transport starwheel is preferably designed as a pitch varying starwheel.

The transfer device is preferably a separate module which is designed as a clean room. The transfer device preferably has interfaces which are complementary to the interfaces of the blow module and the filler module. In an assembled state, the transition from the transfer device to the blow module or to the filler module can preferably be sealed such as to be airtight. This transition is preferably welded during assembly of the system.

In an advantageous embodiment, the filler module has at least three transport starwheels, wherein at least one first transport starwheel of the filler module is a pitch varying starwheel. Preferably, the at least three transport starwheels are arranged such that the plastic preforms can be transferred from the transfer device to the filling device via the at least three transport starwheels. In an advantageous embodiment, the transfer device has at least two transport starwheels.

In a further advantageous embodiment, a second transport starwheel of the filler module is a pitch varying starwheel and/or a first transport starwheel of the transfer device is an orientation starwheel. In this connection, an orientation starwheel is understood to mean a transport starwheel which serves to correctly align the plastic containers taken over from the pitch varying starwheel on the outlet side of the blow module for subsequent filling.

The use of a transfer device as a separately insertable module is advantageous because it makes it easier to respond to customer requests when planning a system. While the blow module and/or the filler module typically have a predefined layout which, due to the size of the base carrier or the spatial dimensions of the clean room and the associated technology, leaves little space for adaptations, such as, for example, the additional arrangement of an orientation starwheel, an inspection device, an ejection device and the like, this can easily be compensated by a corresponding configuration of the transfer device.

In the above-mentioned embodiment, the apparatus has an additional orientation starwheel compared to the embodiment without a transfer device. It would also be conceivable to arrange an additional inspection device in the transfer device for checking whether the plastic containers are correctly aligned by the orientation starwheel. Furthermore, it is also conceivable to additionally provide for an ejection device that will remove any plastic containers from the transport path that have been identified as being incorrectly aligned.

In an alternative embodiment, a first transport starwheel of the transfer device is a pitch varying starwheel. This embodiment offers the advantage that a pitch changing starwheel as part of the filler module can be dispensed with. In a further advantageous embodiment, a second transport starwheel of the transfer device is an orientation starwheel. Here as well, the numbering of the transport starwheels as the first or second transport starwheel does not refer to a defined sequence of the transport starwheels.

The present invention is furthermore directed to a method for operating an apparatus for treating plastic containers having a transport device which transports the plastic containers along a predetermined transport path. Furthermore, the apparatus has a blow module which has a blow molding machine for shaping plastic preforms into plastic containers, wherein the blow module has a transport starwheel on the outlet side, said transport starwheel preferably being designed as a pitch varying starwheel. Furthermore, the apparatus has a filler module which has a filling device for filling plastic containers with an, in particular, liquid product. Furthermore, the blow module and the filler module have an interface which enables a side-by-side arrangement of the blow module and the filler module and wherein the plastic containers are transferred from the blow module to the filler module, wherein the device is arranged within a clean room.

According to the invention, the blow module and the filler module are arranged directly adjacent to one another, and the plastic containers are transferred directly from the blow module to the filler module.

In a preferred method, the plastic containers are transferred from a pitch of the blow molding machine to a pitch of the filling device. Preferably, the pitch distances are changed by the pitch varying starwheel on the outlet side of the blow module and by at least one pitch varying starwheel of the filling device. In an advantageous method, the filler module has a pitch varying starwheel, and the plastic containers are transferred from a pitch of the blow module to a pitch of the filler module.

Preferably, the pitch changing starwheel moves from each second pitch to each pitch (2:1) or from each pitch to each pitch (1:1). Preferably, the pitch changing starwheel can be switched manually or automatically.

As already described above in connection with the apparatus, the modular design make it possible to “insert” a transfer device between the blow module and the filler module. Therefore, the present invention is furthermore directed to a method for operating an apparatus for treating plastic containers having a transport device which transports the plastic containers along a predetermined transport path. Furthermore, the apparatus has a blow module which has a blow molding machine for shaping plastic preforms into plastic containers, wherein the blow module has a transport starwheel on the outlet side, said transport starwheel preferably being designed as a pitch varying starwheel. Furthermore, the apparatus has a filler module which has a filling device for filling plastic containers with an, in particular, liquid product, wherein the plastic containers are transferred from the blow module to the filler module, wherein the apparatus is arranged within a clean room.

According to the invention, a transfer device for transferring the plastic containers is arranged between the blow module and the filler module, and the plastic containers are transferred by the transfer device from the blow module to the filler module.

Preferably, the filler module has at least three transport starwheels, wherein at least one first transport starwheel of the filler module is a pitch varying starwheel. Preferably, the plastic preforms are transferred from the transfer device to the filling device via the at least three transport starwheels of the filler module. Preferably, one of the transport starwheels of the filler module is a pitch changing starwheel.

In an advantageous method, the transfer device has at least two transport starwheels. Preferably, one of the at least two transport starwheels of the transfer device is a pitch varying starwheel or an orientation starwheel.

In an advantageous method, the plastic containers are transferred from a pitch of the blow module to a pitch of the filler module by a pitch varying starwheel of the filler module. In an advantageous method, the plastic containers are aligned by an orientation starwheel of the transfer device.

In an alternative advantageous method, the plastic containers are transferred from a pitch of the blow module to a pitch of the filler module by a pitch changing starwheel of the transfer device. In this embodiment, the transfer device preferably has an orientation starwheel.

### BRIEF DESCRIPTION OF THE DRAWINGS

Further advantages and embodiments can be seen in the accompanying drawings.

In the drawings:

FIG. 1 shows an apparatus according to the invention in a first embodiment; and

FIG. 2 shows an apparatus according to the invention in a second embodiment.

### DETAILED DESCRIPTION OF THE INVENTION

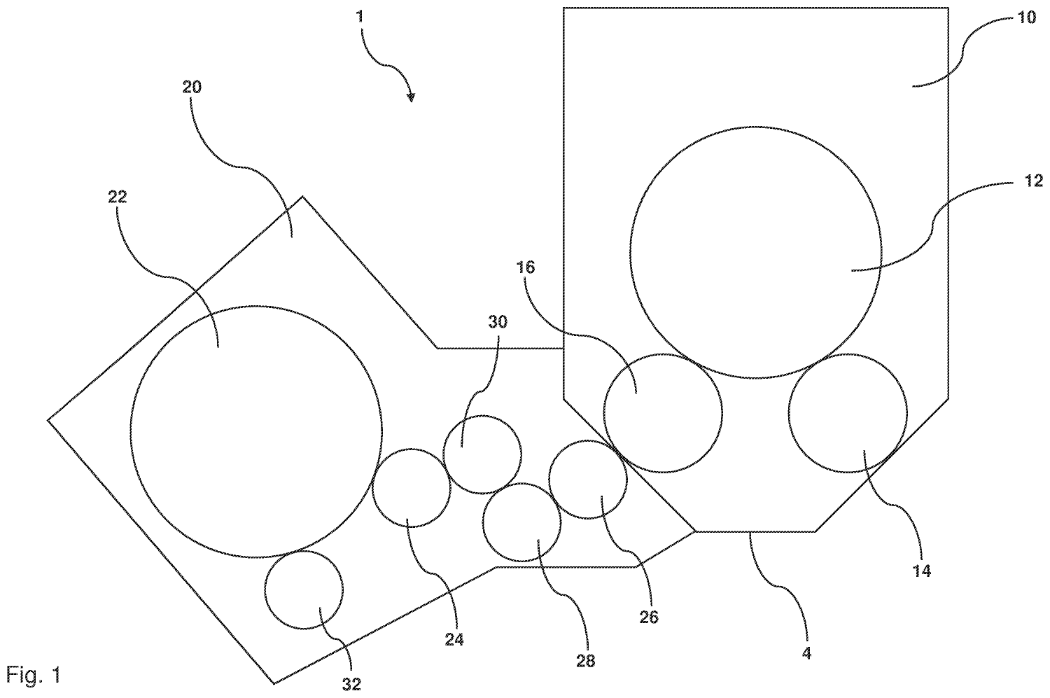

FIG. 1 shows an apparatus 1 according to the invention in accordance with a first embodiment. An arrangement of a blow module 10 and a filler module 20, which are arranged directly adjacent to one another, is shown. Reference sign 4 schematically designates the clean room boundary. The continuous line extending between the blow module 10 and the filler module 20 does not represent a continuous clean room boundary. Rather, the clean rooms of the two modules are connected to one another in the region where the plastic containers are transferred between the pitch varying starwheel 16 of the blow module 10 to the transport starwheel 26 of the filler module 20. The blow module 10 has an infeed starwheel 14, via which previously heated and sterilized plastic preforms are fed to the blow molding machine 12. Subsequently, the finished blown plastic containers are taken over by a pitch varying starwheel 16. In the embodiment shown here, the filler module 20 directly adjoins the blow module 10. The filler module has a filling device 22 and several transport starwheels. In the embodiment shown in the form of an infeed starwheel 24 and three transport starwheels 26, 28, 30, wherein a transport starwheel is designed as a pitch varying starwheel. The transport starwheel 24 (infeed starwheel) is designed as a pitch varying starwheel and transfers the plastic containers to be filled to the filling device 22. Thus, the plastic containers produced by the blow molding machine 12 are transferred by the pitch varying starwheel 16 (outfeed starwheel) to the filling device 22 via the transport starwheels 24, 26, 28, 30 for filling with an, in particular, liquid product, wherein the filling device 22 is followed by an outfeed starwheel 32. In the further course (not shown), the filled plastic containers can be transferred further to a device for closing, labeling, packaging and the like.

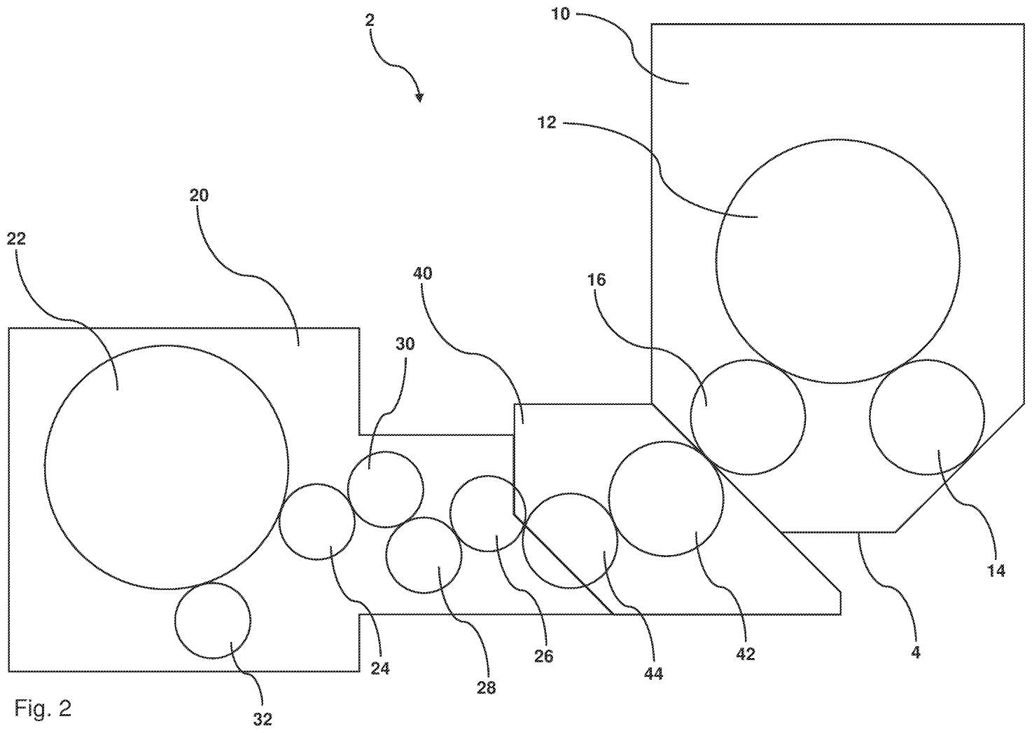

FIG. 2 shows a second embodiment of an apparatus 2 according to the invention. Unlike in the embodiment shown in FIG. 1, a transfer device 40 is located between the blow module 10 and the filler module 20. In turn, reference sign 4 designates the clean room boundary. The transfer device 40 has two transport starwheels which, in a preferred embodiment, are designed as an orientation starwheel 42 and as a pitch varying starwheel 44. In this case, the plastic containers produced by the blow molding machine 12 are transferred by the pitch varying starwheel 16 (blow module outlet) to the orientation starwheel 42 of the transfer device 40. The orientation starwheel 42 serves to correctly align the plastic containers taken over from the blow module 10. This is followed by a pitch changing starwheel 44. After the pitch changing starwheel 44, the plastic containers are transferred to the infeed starwheel of the filling device (pitch varying starwheel 24) via the transport starwheels 26, 28, 30. In an alternative embodiment (not shown), it is conceivable for the pitch changing starwheel 44 to not be arranged in the transfer device, but instead for one of the transport starwheels 26, 28, 30 to be designed as a pitch changing starwheel.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

### LIST OF REFERENCE SIGNS

1 apparatus
2 apparatus
4 clean room boundary
10 blow module
12 blow molding machine
14 infeed starwheel of blow module
16 outfeed starwheel of blow module, pitch varying starwheel
20 filler module
22 filling device
24 infeed starwheel of filling device, pitch varying starwheel
26, 28, 30 transport starwheels
32 outfeed starwheel of filling device
40 transfer device
42 orientation starwheel
44 pitch changing starwheel

1. An apparatus for treating plastic containers having a transport device which transports the plastic containers along a predetermined transport path, a blow module which has a blow molding machine for shaping plastic preforms into plastic containers, and a filler module which has a filling device for filling plastic containers with a product, wherein the blow module and the filler module have an interface which enables a side-by-side arrangement of the blow module and the filler module, and wherein the plastic containers can be transferred from the blow module to the filler module, wherein the apparatus is arranged within a clean room,
wherein
the blow module and the filler module are arranged directly adjacent to one another, wherein the blow module has a transport starwheel on the outlet side, which transport starwheel is designed as a pitch varying starwheel and the plastic containers can be transferred directly from the pitch varying starwheel of the blow module to the filler module.

2. The apparatus according to claim 1,
wherein
the filler module has at least three transport starwheels, wherein a first transport starwheel of the filler module is a pitch varying starwheel and/or a second transport starwheel of the filler module is a pitch changing starwheel.

3. An apparatus for treating plastic containers having a transport device which transports the plastic containers along a predetermined transport path, a blow module which has a blow molding machine for shaping plastic preforms into plastic containers, and a filler module which has a filling device for filling plastic containers with a product, and wherein the plastic containers can be transferred from the blow module to the filler module, wherein the apparatus is arranged within a clean room,
wherein
a transfer device for transferring the plastic containers is arranged between the blow module and the filler module, wherein the blow module has a transport starwheel on the outlet side, which transport starwheel is designed as a pitch varying starwheel.

4. The apparatus according to claim 3,
wherein
the filler module has at least three transport starwheels, wherein at least one first transport starwheel of the filler module is a pitch varying starwheel.

5. The apparatus according to claim 3,
wherein
the transfer device has at least two transport starwheels.

6. The apparatus according to claim 5,
wherein
a second transport starwheel of the filler module is a pitch changing starwheel and/or a first transport starwheel of the transfer device is an orientation starwheel.

7. The apparatus according to claim 5,
wherein
a first transport starwheel of the transfer device is a pitch varying starwheel.

8. The apparatus according to claim 5,
wherein
a second transport starwheel of the transfer device is an orientation starwheel.

9. A method for operating an apparatus for treating plastic containers having a transport device which transports the plastic containers along a predetermined transport path, a blow module which has a blow molding machine for shaping plastic preforms into plastic containers, wherein the blow module has a transport starwheel on the outlet side, which transport starwheel is designed as a pitch varying starwheel, and a filler module which has a filling device for filling plastic containers with a product, wherein the blow module and the filler module have an interface which enables a side-by-side arrangement of the blow module and the filler module, and wherein the plastic containers are transferred from the blow module to the filler module, wherein the apparatus is arranged within a clean room,
wherein
the blow module and the filler module are arranged directly adjacent to one another, and the plastic containers are transferred directly from the blow module to the filler module.

10. The method according to claim 9,
wherein the filler module has a pitch changing starwheel, and the plastic containers are transferred from a pitch of the blow module to a pitch of the filler module.

11. A method for operating an apparatus for treating plastic containers having a transport device which transports the plastic containers along a predetermined transport path, a blow module which has a blow molding machine for shaping plastic preforms into plastic containers, wherein the blow module has a transport starwheel on the outlet side, which transport starwheel is designed as a pitch varying starwheel, and a filler module which has a filling device for filling plastic containers with a product, wherein the plastic containers are transferred from the blow module to the filler module, wherein the apparatus is arranged within a clean room,
wherein
a transfer device for transferring the plastic containers is arranged between the blow module and the filler module, and the plastic containers are transferred by the transfer device from the blow module to the filler module.

12. The method according to claim 11,
wherein
the transfer device has at least two transport starwheels.

13. The method according to claim 11,
wherein
the plastic containers are transferred from a pitch of the blow module to a pitch of the filler module by a pitch changing starwheel of the filler module.

14. The method according to claim 13,
wherein
the plastic containers are aligned by an orientation starwheel of the transfer device.

15. The method according to claim 11,
wherein
the plastic containers are transferred from a pitch of the blow module to a pitch of the filler module by a pitch changing starwheel of the transfer device.
